(19) United States
(12) Patent Application Publication
(10) Pub. No.: US 2013/0091322 A1
(43) Pub. Date: Apr. 11, 2013

(54) Electronic System and Memory Managing Method Thereof

(71) Applicants: Tse-Wei Wang, Taipei City (TW); Wen-Hao Sung, Zhubei City (TW); Chien-Hsiang Li, Taipei City (TW)

(72) Inventors: Tse-Wei Wang, Taipei City (TW); Wen-Hao Sung, Zhubei City (TW); Chien-Hsiang Li, Taipei City (TW)

(73) Assignee: MSTAR SEMICONDUCTOR, INC., Hsinchu Hsien (TW)

(21) Appl. No.: 13/371,588

(22) Filed: Feb. 13, 2012

(30) Foreign Application Priority Data
Oct. 6, 2011 (TW) 100136362

(51) Int. Cl. G06F 12/02

(52) U.S. Cl. 711/103; 711/E12.008

(57) ABSTRACT

A memory managing method for an electronic system is provided. The electronic system includes an auxiliary memory, and is capable of communicating with a flash memory including a plurality of blocks. Each of the blocks has a logical/physical address mapping relationship. The address mapping relationships are stored in a storage region in the flash memory. The memory managing method first determines whether the address mapping relationships stored in the storage region are correct. The address mapping relationships are copied from the storage region to the auxiliary memory when a determination result is affirmative.

This application claims the benefit of Taiwan application Serial No. 100136362, filed Oct. 6, 2011, the subject matter of which is incorporated herein by reference.

### BACKGROUND OF THE INVENTION

1. Field of the Invention

The invention relates in general to a flash memory, and more particularly, to a technique for logical/physical address mapping relationship mapping management of a flash memory.

2. Description of the Related Art

Flash memory has the advantaged of having large capacity, low cost and fast access speed, and thus prevails in various consumer electronic products. Apart from storing user data, flash memory is also commonly utilized for storing software data and programs that occupy large amounts of memory space, such as operating systems. The lifespan of flash memory is largely dependable on the frequency of use; frequent writing and erasing of a certain blocks in the flash memory shorten the lifespan of or even damage those blocks, and further jeopardize the use of the overall flash memory.

To evenly prolong the lifespan of the blocks in flash memory, a translation layer is introduced into firmware of the flash memory. The translation layer functions to evenly distribute the utilization frequencies of the blocks in the flash memory. In general, when an application program wishes to read from/write to the flash memory, rather than directly driving the flash memory, a logical address of a desired block is first converted to a physical address via the translation layer in order to correctly find the block. Hence, how to establish and maintain a correct logical/physical address mapping table is closely related to execution efficiency of the above translation layer.

Each of the blocks of the flash memory is usually recorded with its logical/physical address mapping relationship. In other words, the relationships are distributed and stored in different blocks of the flash memory. It should be noted that, the relationships vary. In current techniques, in an initialization procedure each time an electronic system is booted or reset, firmware in the flash memory scans all of the blocks to read the latest logical/physical mapping relationships of the blocks, and rebuilds in an auxiliary memory of the electronic system a logical/physical address mapping table that is to be subsequently used by a translation layer.

However, a major drawback of the current techniques is that, the process of scanning all of the blocks is quite time-consuming. As the capacity of flash memory increases along with the advancement of manufacturing processes, time for rebuilding the mapping table is also significantly increased which can severely affect system performance.

### SUMMARY OF THE INVENTION

An embodiment of the invention is directed to a novel memory control solution. By establishing a storage region in a flash memory and centralizing storing logical/physical address mapping relationships of all blocks of the flash memory, the memory control solution of the present invention is capable of effectively shortening the time needed for rebuilding an address mapping table in an auxiliary memory of an electronic system, thereby optimizing overall efficiency of the electronic system.

According to an embodiment of the present invention, a memory managing method for an electronic system is provided. The electronic system comprises an auxiliary memory, and is capable of communication with a flash memory comprising a plurality of blocks. Each of the blocks comprises a logical/physical address mapping relationship. The logical/physical address mapping relationships are stored in a storage region in the flash memory. The method comprises steps of: a) determining whether the logical/physical address mapping relationships stored in the storage region are correct; and b) reproducing the logical/physical address mapping relationships from the storage region to the auxiliary memory for reference of the electronic system when the electronic system communicates with the flash memory when a determination result from Step (a) is affirmative.

According to an embodiment of the present invention, a computer-readable storage medium stored with a code readable and executable by an electronic system is provided. The electronic system comprises an auxiliary memory, and is capable of communicating with a flash memory comprising a plurality of blocks. Each of the blocks comprises a logical/physical address mapping relationship. The logical/physical address mapping relationships are stored in a storage region in the flash memory. The code is for managing the flash memory, and comprises: a first sub-code, for determining whether the logical/physical address mapping relationships stored in the storage region are correct; and a second sub-code, for reproducing the logical/physical address mapping relationships from the storage region to the auxiliary memory for reference of the electronic system when the electronic system communicates with the flash memory when a determination result of the first sub-code is affirmative.

According to an embodiment of the present invention, an electronic system comprising an auxiliary memory and a controller is provided. The electronic system is capable of communicating with a flash memory comprising a plurality of blocks. Each of the blocks comprises a logical/physical address mapping relationship. The logical/physical address mapping relationships are stored in a storage region in the flash memory. When the flash memory is coupled to the electronic system, the controller respectively couples to the auxiliary memory and the flash memory. In an initialization procedure of the electronic system, the controller first determines whether the logical/physical address mapping relationships stored in the storage region are correct, and copies the logical/physical address mapping relationships from the storage region to the auxiliary memory for reference of the electronic system when the electronic system communicates with the flash memory.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIGS. 1, 3 and 4 are schematic diagrams of examples of contents of a flash memory according to an embodiment of the present invention.

FIGS. 2 and 5 are flowcharts of a memory managing method according to embodiments of the present invention.

FIG. 6 is a block diagram of an electronic system according to an embodiment of the present invention.

### DETAILED DESCRIPTION OF THE INVENTION

According to an embodiment of the present invention, a memory managing method for an electronic system is provided. The memory managing method of the present invention is capable of optimizing efficiency of the electronic system in building an address mapping table for a flash memory. For example, the electronic system is a digital camera, a mobile communication system, a portable computer, a desktop computer or external storage devices adopting a flash memory. The concept of the present invention is applicable to both a NAND flash memory and a NOR flash memory. In practice, the flash memory may be directly built in the electronic system, or may be a memory card or a portable disk connected to the electronic system via various connection devices.

The flash memory comprises a plurality of blocks, each corresponding to a logical/physical mapping relationship. Taking an unsorted block image file system (UBIFS) specification for a Linux system as an example, the logical/physical address mapping relationships of the blocks are recorded in EC/Vid headers of the blocks, respectively. Each of the blocks comprises a plurality of same-sized pages, and the EC/Vid header is located at the first two pages of the blocks. According to an embodiment of the present invention, in the flash memory, a specific storage region is provided for further centralized storing of a copy of the logical/physical address mapping relationships of the blocks. For example, the address mapping relationship information may be stored as a look-up table. To distinguish the specific storage region from other memory regions, the storage region is denoted as a table storage region in the descriptions below.

In practice, the table storage region may be located in one block or distributed in several blocks of the flash memory, and the logical/physical address mapping relationships may be stored in one page or several pages of the one block or the several blocks. A capacity of the table storage region is associated with a number and a content size of the logical/physical address mapping relationships. Taking the UBIFS specification as an example, the size of the EC/Vid header of each block is 128 bytes, and thus a 2048-byte page is capable of storing logical/physical address mapping relationships of 16 blocks. In other words, the capacity of the table storage region must get larger as the number of blocks of the flash memory increases in order to store compact logical/physical address mapping relationships of the blocks of the flash memory.

Tasks of establishing the table storage region and reproducing the logical/physical address mapping relationships from the blocks to the table storage region may be completed with assistance of memory managing firmware of the electronic system when the flash memory is used for the first time after the electronic system is initialized. It should be noted that, the logic/physical address mapping relationships may vary when the memory is in use. Apart from the pages stored with the most updated address mapping relationship information, the table storage region may also comprise other backup storage pages as substitutive pages saved for further address mapping relationship information updates, so as to prevent certain pages from excessive repeated use. For example, the number of pages storing the latest address mapping relationship information may be 10, and the table storage region may comprise 10 or 20 backup storage pages.

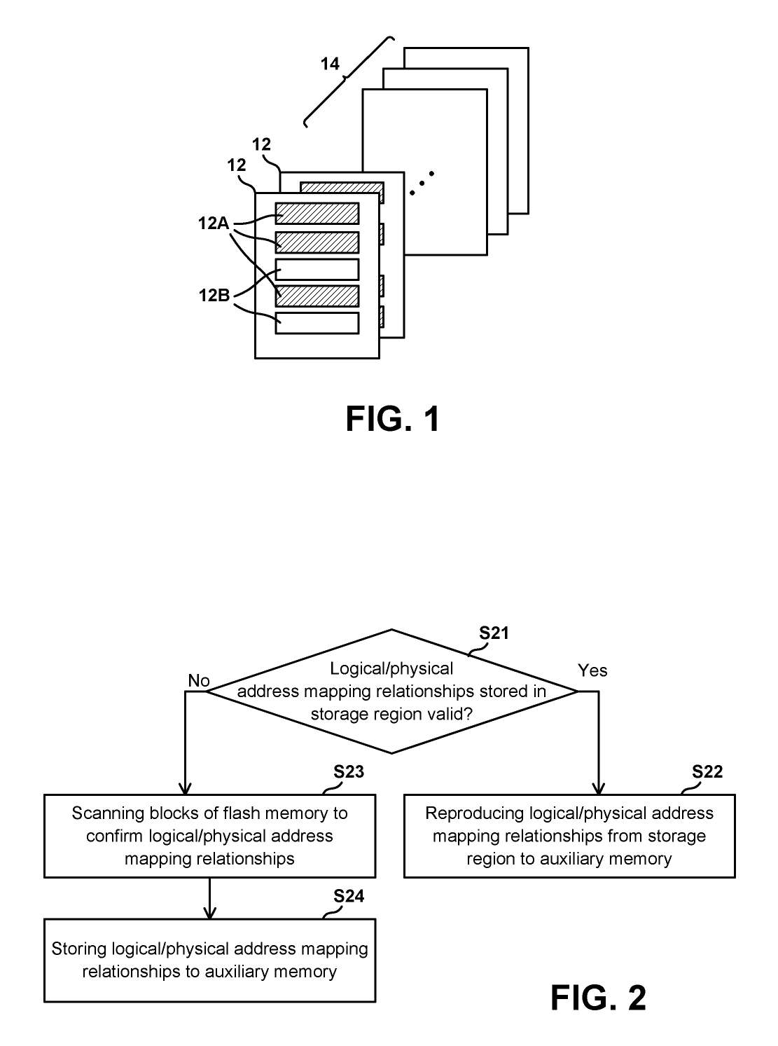

FIG. 1 shows a schematic diagram depicting a content of a flash memory according to an embodiment of the present invention. In this embodiment, a table storage region 12 comprises two blocks, and other blocks with a notation 14 represent blocks for storing user data or application program data of the electronic system. In the table storage region 12, a plurality of pages 12A are storage pages storing the latest address mapping relationship information, and a plurality of pages 12B are backup storage pages. In other words, besides being stored in respective blocks, the logical/physical address mapping relationship information of the blocks 14 also has a copy centralized stored in the storage pages 12A and the backup storage pages 12B.

The electronic system implementing the memory managing method according to an embodiment of the present invention furthur comprises an auxiliary memory, e.g., a random-access memory (RAM). During an initialization procedure when the electronic system is booted or reset, the logical/physical address mapping relationship information in the blocks of the flash memory is copied to the auxiliary memory, as a reference to the electronic system when the electronic system communicates with the flash memory later.

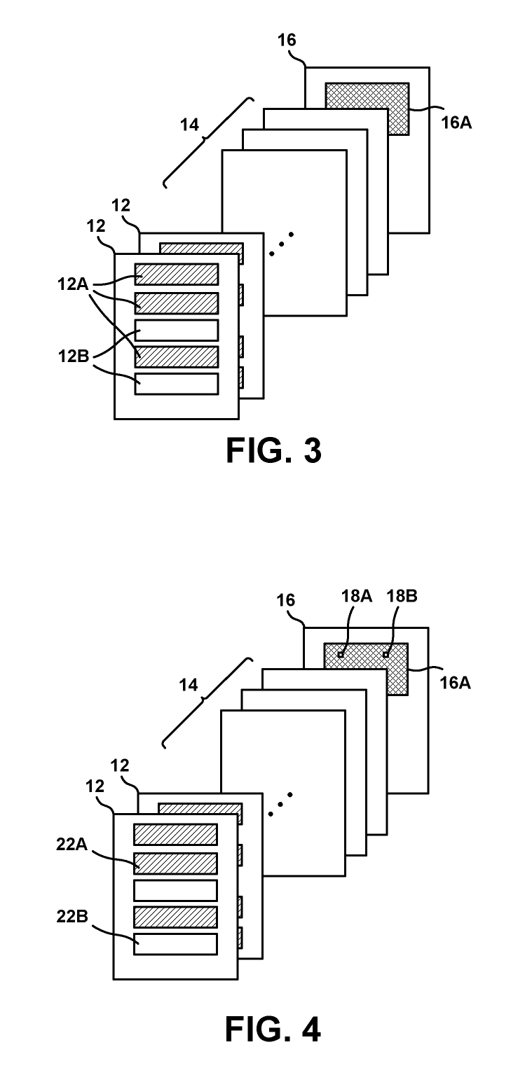

FIG. 2 shows a flowchart of the memory managing method according to this embodiment. In practice, the method may be executed by software, firmware or hardware in the electronic system. As shown in FIG. 2, after the electronic system is initialized, Step S21 is performed to determine whether the logical/physical address mapping relationships stored in the table storage region 12 are valid. In practice, in the event that the electronic system is unexpectedly shut down or unexpectedly powered off, errors may occur in the address mapping relationship information in the table storage region 12. For example, it is possible that the logical/physical address mapping relationship of a specific block is changed, or the content of the table storage region 12 may be invalid since the electronic system is unexpectedly powered off before the content of the table storage region 12 can be updated to the latest version. The purpose of Step S21 is to prevent reproducing faulty address information to the auxiliary memory.

When a determination result from Step S21 is affirmative, Step S22 is performed to reproduce the logical/physical address mapping relationships from the table storage region 12 to the auxiliary memory as a reference to the electronic system when the electronic system communicates with the flash memory. Conversely, when the determination result from Step S21 is negative, Step S23 is performed to scan the blocks 14 to confirm the logical/physical address mapping relationships of the blocks 14. Next, Step S24 comprises storing the logical/physical address mapping relationships obtained from Step S23 to the auxiliary memory as a reference to the electronic system when the electronic system communicates with the flash memory.

It is seen from the above descriptions that, the address mapping relationship information that is centralized stored in the table storage region 12 may be directly copied to the auxiliary memory of the electronic system when the logical/physical address mapping relationships stored in the table storage region 12 are valid, so as to eliminate the procedure of re-scanning all the blocks 14. Compared to the conventional approach of having to re-scan all the blocks 14 every time, the method of the present invention effectively reduces the time required for rebuilding the address mapping table in the auxiliary memory of the electronic system.

Referring to FIG. 3, according to an embodiment of the present invention, the flash memory further comprises a control storage region 16, which stores a page validity location bitmap 16A for indicating validity of the storage pages 12A or the backup storage pages 12B. The validity means whether a specific page contains correct logical/physical address mapping relationships. In other words, the page validity location bitmap 16A indicates whether a specific page is a storage page 12A stored with the latest logical/physical address mapping relationships or a backup storage page.

Assume that the page validity location bitmap 16A is a binary bitmap, for example, the page validity location bitmap 16A is a binary sequence [10100100100 . . . ], with each of the bits corresponding to a storage page 12A or a backup storage page 12B. In this embodiment, a bit 1 corresponds to a valid page (i.e., the storage page 12A), whereas a bit 0 corresponds to an invalid page (i.e., a backup storage page 12B). The bits in the sequence respectively correspond to each of the storage pages 12A and each of the backup storage pages 12B in the table storage region 12. Assuming that the order of the bits in the sequence corresponds to the order of the pages in the table storage region, locations of the storage pages 12A in the table storage region 12 may be identified from the sequence.

In practice, the page validity location bitmap 16A may be established with assistance of memory managing firmware of the electronic system when the flash memory is used for the first time, and is not limited to a binary bitmap. During an initialization procedure of the electronic system, the firmware of the electronic system may determine which pages in the table storage region 12 need to be read according to the page validity location bitmap 16A. Furthermore, before shutting down the electronic system, the firmware of the electronic system may also be in charge of confirming that all logical/physical address mapping relationships modified by the operating system are updated to the table storage region 12, as well as confirming the stored page validity location bitmap 16A is a latest binary bitmap.

In an embodiment, apart from the above sequence, the page validity location bitmap 16A also stores a flag for marking whether the page validity location bitmap 16A is correct. Every time when the logical/physical address mapping relationship of a specific block is modified, the flag may first be set to 0. The flag is then set to 1 only when it is confirmed that the table storage region 12 and the page validity location bitmap 16A are also correctly updated. Therefore, Step S21 in FIG. 2 may comprise directly determining whether the logical/physical address mapping relationships stored in the storage region are correct according to the flag with a value of 0 or 1. More specifically, in this embodiment, when the determination result from Step S21 shows the flag is 0, Steps S23 and S24 shall be performed; when the determination result from Step S21 shows the flag is 1, Step S22 shall be performed.

FIG. 4 is for illustrating how the contents of the table storage region 12A and the page validity location bitmap 16A are modified when the logical/physical address mapping relationship of a specific block is changed. The page validity location bitmap 16A is a binary bitmap. In this example, the logical/physical address mapping relationship to be modified is originally stored in a target page 22A in the table storage region 12, and the target page 22A corresponds to a target bit 18A in the page validity location bitmap 16A. Before the modification procedure begins, an original value of the target bit 18A is 1. When the target relationship is modified to a modified mapping relationship, the target bit 18A is set to 0 to indicate that the original content of the target page 22A is no longer entirely correct. The modified relationship and other logical/physical address mapping relationships originally stored in the target page 22a are written to a page 22B previously serving as a backup page. The bit 18B in the page validity location bitmap 16A corresponding to the page 22B is 0. After confirming the writing procedure to the page 22B is completed, the value of the bit 18B in the 16A corresponding to the page 22B is set to 1.

The above modification procedure provides an advantage that, the bit 18B is not set to 1 until the page 22B is modified to the correct content. In other words, if an unexpected abnormality of the electronic system has occurred, the content of the page 22B would not be taken as correct content immediately after the system is restored from the abnormality, but the electronic system waits until the writing procedure to the page 22B is completed. In practice, previously stored data in the target page 22A may be erased to make the target page 22A as a backup page. Furthermore, right after the modification on the page validity location bitmap 16A is completed, firmware of the electronic system may also synchronously update the address mapping table in the auxiliary memory of the electronic system according to the modified content.

It can be seen from the above descriptions that the number of bits in a value of 1 in the page validity location bitmap 16A is a constant value when the content of the table storage region 12 is entirely correct. Taking the table storage region 12 comprising 32 pages and the number of the storage pages 12A being 10 as an example, under normal circumstances, the number of bits with a value of 1 in the page validity location bitmap 16A is 10, and the number of bits with a value of 0 is then 22. Supposing an unexpected abnormality takes place in the electronic system, the number of bits with a value of 1 is 9, and the number of bits with a value of 0 is 23.

Furthermore, the number of bits in a value of 1 in the page validity location bitmap 16A may also serve as basis for determining whether the content of the table storage region 12 is entirely correct. FIG. 5 shows a flowchart of a memory managing method according to the embodiment of the present invention. As shown in FIG. 5, Step S31 comprises determining whether the number of bits with a value of 1 in the page validity location bitmap 16A is smaller than a predetermined value (e.g., 10 as in the above example). When a determination result from Step S31 shows the number of bits in a value of 1 in the page validity location bitmap 16A equals the predetermined value, it means the content of the table storage region 12 is entirely correct, and Step S32 shall be performed. In Step S32, the logical/physical address mapping relationships are copied from the table storage region 12 to the auxiliary memory of the electronic system.

Conversely, when the determination result from Step S31 is negative, Steps S32 to S35 are performed. Step S33 comprises determining logical/physical address mapping relationships of which of the blocks in the flash memory need to be confirmed according to the valid storage pages (i.e., the pages corresponding to the bits with a value of 1 in the page validity location bitmap 16A). It should be noted that the storage pages are recorded with information of the logical/physical address mapping relationships of which blocks are stored. Therefore, according to the contents of the valid storage pages, it may be identified that logical/physical address mapping relationships of which blocks stored in the table storage region 12 are correct, as well as logical/physical address mapping relationships of which blocks 14 are incorrect. Next, Step S34 comprises scanning the blocks 14 that are determined as the table storage region 12 storing incorrect logical/physical address mapping relationships of the blocks 14 from Step S33, so as to confirm the logical/physical address mapping relationships of the blocks 14. Step S35 comprises storing the logical/physical address mapping relationships obtained from Step S34 and the logical/physical address mapping relationships stored in the valid storage pages determined from Step S33 to the auxiliary memory of the electronic system.

In the above embodiment, the firmware of the electronic system need not re-scan all the blocks 14 even when the content in the table storage region 12 is faulty. In other words, the correct part of the content of the table storage region 12 may still be directly copied to the auxiliary memory. On average, the above solution further shortens the time needed for rebuilding the address mapping table in the auxiliary memory of the electronic system.

According to another embodiment of the present invention, a computer-readable storage medium is provided. The computer-readable storage medium stores code that is readable and executable by an electronic system. For example, the code can be memory managing firmware installed in the electronic system. The electronic comprises an auxiliary memory and is capable of communicating with a flash memory comprising a plurality of blocks. Each of the blocks comprises a logical/physical address mapping relationship. The logical/physical address mapping relationships are stored in a storage region in the flash memory. The code is for managing the flash memory, and comprises: a first sub-code, for determining whether the logical/physical address mapping relationships stored in the storage region are correct; and a second sub-code, for reproducing the logical/physical address mapping relationships from the storage region to the auxiliary memory as a reference to the electronic system when the electronic system communicates with the flash memory, when a determination result of the first sub-code is affirmative.

According to another embodiment of the present invention, the first sub-code may be modified to determining whether the logical/physical address mapping relationships stored in the table storage region are correct according to the flag or the number of bits with a value of 1 in the page validity location bitmap 16A. In addition, the code may further comprise sub-codes for respectively performing Steps S33 to S35 in FIG. 5. According to another embodiment, the code of the present invention may also further comprise a sub-code for realizing the foregoing modification procedure.

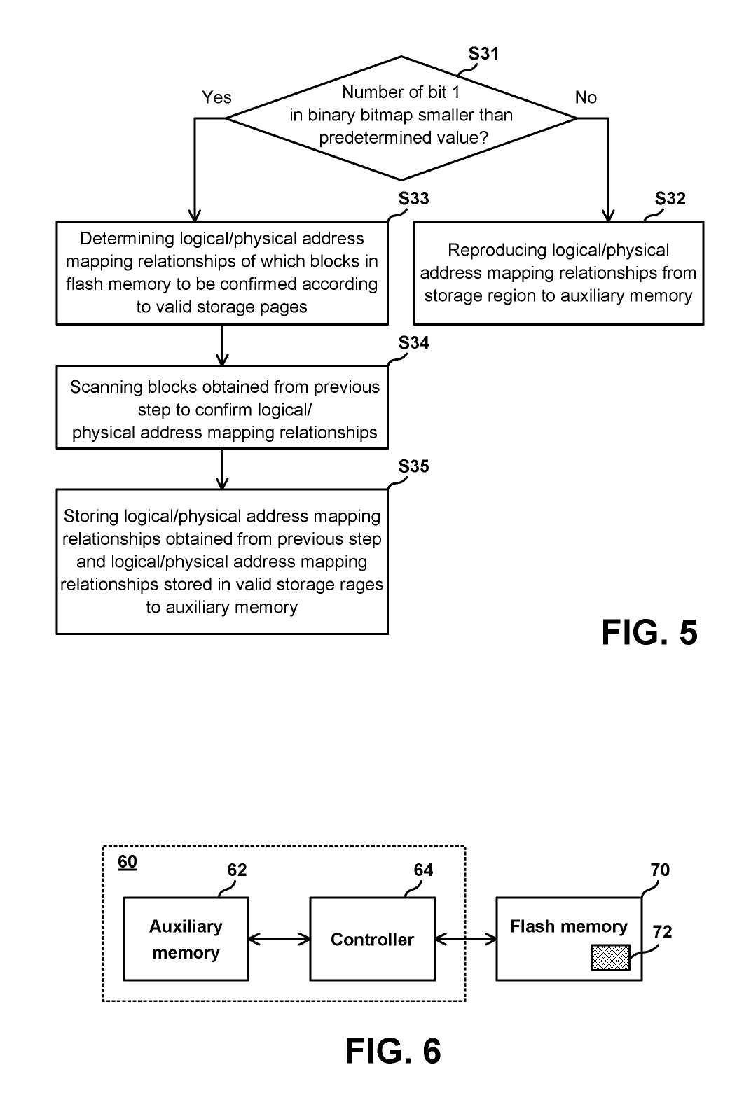

According to yet another embodiment of the present invention, an electronic system 60 as shown in FIG. 6 is provided. The electronic system 60 comprises an auxiliary memory 62 and a controller 64. To clearly present technical features of the present invention, other possible hardware devices in the electronic system 60 are not depicted in the diagram. The electronic system 60 is capable of communicating with a flash memory 70, which comprises a plurality of blocks, each comprising a logical/physical address mapping relationship, and a storage region 72 storing the logical/physical address mapping relationships. When the flash memory 70 is coupled to the electronic system, the controller 64 is coupled to the auxiliary memory 62 and the flash memory 70, respectively.

During an initialization procedure of the electronic system 60, the controller 64 first determines whether the logical/physical address mapping relationships stored in the storage region 72 are correct. When a determination result is affirmative, the controller 64 copies the logical/physical address mapping relationships from the storage region 72 to the auxiliary memory 62 as a reference to the electronic system 60 when the electronic system 60 communicates with the flash memory 70. In practice, the controller 63 may be designed as comprising a determining unit for performing Steps 31 and 33, a scanning unit for performing Step S34, and a reproducing unit for performing Step S35. Operation details of the units may be appreciated by the previous description and shall not be further described for brevity.

Furthermore, the controller 64 may also be designed as further comprising a setting unit and a read/write unit. The setting unit is for setting the bits in the page validity location bitmap 16A to 0 or 1. The read/write unit is for writing the modified address mapping relationships and other logical/physical address mapping relationships originally stored in the target page to another page. Similarly, operation details of the two hardware units may be appreciated by the previous description and shall not be further described for brevity.

In conclusion, the present invention provides a novel memory managing solution. By establishing a storage region in a flash memory and centralized storing logical/physical address mapping relationships of all blocks of the flash memory, the memory control solution of the present invention is capable of effectively shortening the time needed for rebuilding an address mapping table in an auxiliary memory of an electronic system, thereby optimizing overall efficiency of the electronic system.

Taking a flash memory comprising 100 blocks in a UBIFS system as an example, the system needs to read 200 pages for rebuilding a logical/physical address mapping table during system initialization before applying the memory managing solution provided by the present invention.

By applying the memory managing solution of the present invention, an average search number of binary bitmaps that are searched for page validity location bitmaps is approximately half of the number of the pages. For example, an average search number for a block comprising 64 pages is 32 pages. Assuming that one page is capable of storing logical/physical address mapping relationships of 16 blocks, only 7 pages are required for adequately storing logical/physical address mapping relationships of 100 blocks. Therefore, the number of pages to be read by the memory firmware reduces from 200 to an average number of 39 pages, and thereby saving around 60% of the originally required time. As the capacity of the pages gets greater or as the number of blocks in the flash memory gets larger, the amount of time saved by applying the memory managing solution of the present invention also gets larger.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory managing method for an electronic system, the electronic system comprising an auxiliary memory capable of communicating with a flash memory comprising a plurality of blocks, each of the blocks having a corresponding logical/physical address mapping relationship, a storage region in the flash memory storing the plurality of logical/physical address mapping relationships, the method comprising:
a) determining whether the logical/physical address mapping relationships stored in the storage region are correct; and;
b) when a determination result is affirmative in step (a), reproducing the logical/physical address mapping relationships from the storage region to the auxiliary memory.

2. The memory managing method according to claim 1, wherein the storage region is located in one of the blocks of the flash memory, and the logical/physical address mapping relationships are stored in a plurality of storage pages in the block.

3. The memory managing method according to claim 2, wherein the flash memory further stores a page validity location bitmap for indicating validities of the plurality of storage pages, each of the validities represents whether the logical/physical address mapping relationships in one of the storage pages are correct, and Step (a) comprises determining whether the logical/physical address mapping relationships stored in the storage region are correct according to the page validity location bitmap.

4. The memory managing method according to claim 3, the page validity location bitmap being stored with a flag, Step (a) comprising determining whether the logical/physical address mapping relationships stored in the storage region are correct according to the flag, the method further comprising:
c1) when the determination result from Step (a) is negative, scanning the blocks in the flash memory to confirm the logical/physical address mapping relationships and
c2) storing the logical/physical address mapping relationships obtained from Step (c1) to the auxiliary memory.

5. The memory managing method according to claim 3, wherein the page validity location bitmap is a binary bitmap, each of the storage pages corresponds to a bit in the binary bitmap, a valid storage page corresponds to a bit 1, an invalid storage pages corresponds to a bit 0, and Step (a) comprises determining whether the logical/physical address mapping relationships stored in the storage region are correct according to a number of bit 1 in the page validity location bitmap.

6. The memory managing method according to claim 5, further comprising:
d1) determining the blocks to be confirmed according to the valid storage pages when the number of bit 1 is smaller than a predetermine value;
d2) scanning the blocks to be confirmed to confirm the logical/physical address of the blocks; and
d3) storing the logical/physical address mapping relationships obtained from Step (d2) and the logical/physical address mapping relationships stored in the valid storage pages to the auxiliary memory.

7. The memory managing method according to claim 5, a target relationship in the logical/physical address mapping relationships being stored in a first target page of the storage pages, the first target page corresponding to a first target bit in the page validity location bitmap, the method further comprising:
setting the first target bit to the bit 0 when the target relationship is modified to a modified relationship;
writing the modified relationship and other logical/physical address mapping relationships in the first target page to a second target page; and
setting a second target bit in the second target page corresponding to the page validity location bitmap to the bit 1.

8. A computer-readable storage medium, being stored with a code readable and executable by an electronic system, the electronic system comprising an auxiliary memory capable of communicating with a flash memory comprising a plurality of blocks, each of the blocks having a corresponding logical/physical address mapping relationship, the plurality of logical/physical address mapping relationships being stored in a storage region in the flash memory, the code comprising:
a first sub-code, for determining whether the logical/physical address mapping relationships stored in the storage region are correct; and
a second sub-code, for reproducing the logical/physical address mapping relationships from the storage region to the auxiliary memory when a determination result of the first sub-code is affirmative.

9. The computer-readable storage medium according to claim 8, wherein the storage region is located in one of the blocks of the flash memory, and the logical/physical address mapping relationships are stored in a plurality of storage pages in the block.

10. The computer-readable storage medium according to claim 9, wherein the flash memory further stores a page validity location bitmap for indicating validities of the plurality of storage pages, each of the validity represents whether the logical/physical address mapping relationships in one of the storage pages are correct, and the first sub-code comprises determining whether the logical/physical address mapping relationships stored in the storage region are correct according to the page validity location bitmap.

11. The computer-readable storage medium according to claim 10, wherein the page validity location bitmap is a binary bitmap, each of the storage pages corresponds to a bit in the binary bitmap, a valid storage page corresponds to a bit 1, an invalid storage pages corresponds to a bit 0, and the first sub-code comprises determining whether the logical/physical address mapping relationships stored in the storage region are correct according to a number of bit 1 in the page validity location bitmap.

12. The computer-readable storage medium according to claim 11, wherein the code further comprises:
a third sub-code, for determining the blocks to be confirmed according to the valid storage pages when a number of bit 1 is smaller than a predetermined value;
a fourth sub-code, for scanning the blocks to be confirmed to confirm the logical/physical address mapping relationships of the blocks; and
a fifth sub-code, for reproducing the logical/physical address mapping relationships obtained by the fourth sub-code and the logical/physical address mapping relationships stored in the valid storage pages to the auxiliary memory of the electronic system.

13. The computer-readable storage medium according to claim 11, wherein a target relationship in the logical/physical address mapping relationships is stored in a first target page of the storage pages, the first target page corresponds to a first target bit in the page validity location bitmap, and the code further comprises:
a sixth sub-code, for setting the first target bit to the bit 0 when the target relationship is modified to a modified relationship;
a seventh sub-code, for writing the modified relationship and other logical/physical address mapping relationships in the first target page to a second target page; and
an eighth sub-code, for setting a second target bit in the second target page corresponding to the page validity location bitmap to the bit 1.

14. An electronic system, capable of communicating with a flash memory comprising a plurality of blocks, each of the blocks having a logical/physical address mapping relationship, a storage region in the flash memory storing the logical/physical address mapping relationships, the electronic system comprising:
an auxiliary memory; and
a controller, coupled to the auxiliary memory, for determining whether the logical/physical address mapping relationships stored in the storage region are correct, and, during an initialization procedure of the electronics system, reproducing the logical/physical address mapping relationships from the storage region to the auxiliary memory.

15. The electronic system according to claim 14, the storage region is located in one of the blocks of the flash memory, and the logical/physical address mapping relationships are stored in a plurality of storage pages in the block.

16. The electronic system according to claim 15, the flash memory further stores a page validity location bitmap for indicating validities of the plurality of storage pages, each of the validities represents whether the logical/physical address mapping relationships in one of the storage pages are correct, and the first sub-code comprises determining whether the logical/physical address mapping relationships stored in the storage region are correct according to the page validity location bitmap.

17. The electronic system according to claim 16, wherein the page validity location bitmap is a binary bitmap, each of the storage pages corresponds to a bit in the binary bitmap, a valid storage page corresponds to a bit 1, an invalid storage pages corresponds to a bit 0, and the first sub-code comprises determining whether the logical/physical address mapping relationships stored in the storage region are correct according to a number of bit 1 in the page validity location bitmap.

18. The electronic system according to claim 17, wherein the controller comprises:
a determining unit, for determining the blocks to be confirmed according to the valid storage pages when the number of bit 1 is smaller than a predetermine value;
a scanning unit, for scanning the blocks to be confirmed to confirm the logical/physical address of the blocks; and
a reproducing unit, for storing the logical/physical address mapping relationships obtained by the scanning unit and the logical/physical address mapping relationships stored in the valid storage pages to the auxiliary memory.

19. The electronic system according to claim 17, wherein a target relationship in the logical/physical address mapping relationships is stored in a first target page of the storage pages, the first target page corresponds to a first target bit in the page validity location bitmap, and the controller further comprises:
a setting unit, for setting the first target bit to the bit 0 when the target relationship is modified to a modified relationship; and
a read/write unit, for writing the modified relationship and other logical/physical address mapping relationships in the first target page to a second target page after the setting unit sets the target bit to the bit 0;
wherein, the setting unit sets a second target bit in the second target page corresponding to the page validity location bitmap to the bit 1 after the read/write unit writes the relationships to the second page.
